(19) United States
(12) Patent Application Publication
(10) Pub. No.: US 2026/0180128 A1
(43) Pub. Date: Jun. 25, 2026

(54) SEPARATOR FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Bich Nam JEONG, Suwon-si (KR); Woo Sung LEE, Suwon-si (KR); Sam Jin PARK, Suwon-si (KR); Yang Seob KIM, Suwon-si (KR)

(73) Assignee: SAMSUNG SDI CO., LTD., Yongin-si (KR)

(21) Appl. No.: 19/428,576

(22) Filed: Dec. 22, 2025

(30) Foreign Application Priority Data
Dec. 24, 2024 (KR) 10-2024-0195894
Dec. 24, 2024 (KR) 10-2024-0195897

(51) Int. Cl. H01M 50/449; H01M 10/0525; H01M 50/42; H01M 50/426; H01M 50/429; H01M 50/44; H01M 50/491

(52) U.S. Cl. CPC H01M 50/449; H01M 10/0525; H01M 50/42; H01M 50/426; H01M 50/4295; H01M 50/44; H01M 50/491

(57) ABSTRACT

Provided are a separator for a rechargeable lithium battery, and a rechargeable lithium battery including the separator. The separator for a rechargeable lithium battery includes a porous substrate, and a first layer located on at least one surface of the porous substrate. The first layer includes a binder and a filler. The binder includes a mixture of a first binder and a second binder. The second binder is an adhesive binder, the second binder includes one or more of polyvinyl alcohol, polyacrylic acid, and poly(vinyl alcohol-co-acrylic acid). The filler includes a mixture of cellulose-based nanofibers having a carboxyl group, cellulose-based nanocrystals having a carboxyl group, and a filler that is not surface-modified.

### CROSS-REFERENCE TO RELATED APPLICATION

The present application claims priority to Korean Patent Application No. 10-2024-0195894, filed on Dec. 24, 2024 in the Korean Intellectual Property Office and Korean Patent Application No. 10-2024-0195897, filed on Dec. 24, 2024 in the Korean Intellectual Property Office, the entire disclosure of each of the above priority applications is incorporated herein by reference.

### BACKGROUND

### 1. Field of the Disclosure

The present disclosure relates to a separator for a rechargeable lithium battery, and a rechargeable lithium battery including the separator.

### 2. Discussion of Related Art

With increasing use of electronic devices using batteries such as, e.g., mobile phones, notebook computers, electric vehicles, and the like, the demand for secondary batteries having high energy density and high capacity is increasing. Therefore, improving the performance of rechargeable lithium batteries may be advantageous.

A rechargeable lithium battery typically includes a positive electrode and a negative electrode that contain an active material capable of the intercalation and deintercalation of lithium ions, and produces electrical energy by oxidation and reduction reactions when the lithium ions are intercalated into and deintercalated from the positive electrode and the negative electrode.

A rechargeable lithium battery may include a separator between the positive and negative electrodes. The separator is impregnated in the electrolyte and bonded to the positive or negative electrode. It may be desirable for the separator to maintain an original shape thereof without undergoing thermal shrinkage in the electrolyte to ensure the safety of the battery.

### SUMMARY

The present disclosure describes a separator for a rechargeable lithium battery which provides high substrate adhesion, a low heat shrinkage rate, and improved air permeability.

The present disclosure also describes a separator for a rechargeable lithium battery which provides high dry adhesion and high wet adhesion.

The present disclosure describes a rechargeable lithium battery, which includes the separator for a rechargeable lithium battery.

One example embodiment includes a separator for a rechargeable lithium battery.

The separator for a rechargeable lithium battery includes a porous substrate, and a first layer located on at least one surface of the porous substrate. The first layer includes a binder and a filler. The binder includes a mixture of a first binder and a second binder. The second binder is an adhesive binder, the second binder includes one or more of polyvinyl alcohol, polyacrylic acid, and poly(vinyl alcohol-co-acrylic acid). The filler includes a mixture of cellulose-based nanofibers with a carboxyl group or carboxylate, cellulose-based nanocrystals with a carboxyl group or carboxylate, and a filler that is not surface-modified.

Another example embodiment includes a separator for a rechargeable lithium battery.

The separator for a rechargeable lithium battery includes a porous substrate, a first layer and a second layer which are located, e.g., sequentially located, on at least one surface of the porous substrate, the first layer includes a binder and a filler. The binder includes a mixture of a first binder and a second binder. The second binder is an adhesive binder, the second binder includes one or more of polyvinyl alcohol, polyacrylic acid, and poly(vinyl alcohol-co-acrylic acid). The filler includes a mixture of cellulose-based nanofibers with a carboxyl group or carboxylate, cellulose-based nanocrystals with a carboxyl group or carboxylate, and a filler that is not surface-modified. The separator also includes the second layer which is an adhesive layer.

Another example embodiment includes a rechargeable lithium battery, which includes the separator for a rechargeable lithium battery, a positive electrode, and a negative electrode.

The separator for a rechargeable lithium battery according to one example embodiment can provide high substrate adhesion, a low heat shrinkage rate, and improved air permeability, thereby increasing the safety and lifetime of the battery.

### BRIEF DESCRIPTION OF THE DRAWINGS

The above and other objects, features and advantages of the present disclosure may become more apparent to those of ordinary skill in the art by describing example embodiments thereof in detail with reference to the accompanying drawings, in which:

FIG. 1 is a cross-sectional view illustrating a separator for a rechargeable lithium battery according to one example embodiment;

FIG. 2 is a cross-sectional view illustrating a separator for a rechargeable lithium battery according to another example embodiment; and

FIG. 3, FIG. 4, FIG. 5 and FIG. 6 are cross-sectional views schematically illustrating a rechargeable lithium battery according to one example embodiment.

### DETAILED DESCRIPTION

Hereinafter, example embodiments of the present disclosure are described in detail. However, these are presented as examples, and the present disclosure is not limited thereby, and the present disclosure is defined only by the scope of the claims described below.

Unless otherwise specified herein, when a part such as a layer, a film, a region, or a plate is described as being “on” another part, this includes not only a case where the part is “directly on” the other part, but also a case where another part is present therebetween.

Unless particularly stated otherwise, what is expressed in the singular may also include the plural. Additionally, unless otherwise specified, “A or B” may mean “including A, including B, or including A and B.”

In the specification, “combination thereof” may mean a mixture, laminate, composite, copolymer, alloy, blend, and reaction product of components.

In the specification, “particle size (D100)” refers to an average particle size indicating the size of particles with a cumulative volume of 100 vol % in the particle size distribution. Particle size distribution may be measured by a method widely known to those of ordinary skill in the art. For example, the particle size distribution may be measured using, e.g., a particle size analyzer, or by transmission electron microscopy or scanning electron microscopy. As another method, by using a measuring device that uses, e.g., dynamic light-scattering, particle size may be measured using dynamic light-scattering, the number of particles may be counted for each particle size range through data analysis, and the D100 value may be obtained by being calculated from the counted number of particles. Alternatively, the number of particles may be measured using a laser diffraction method. When measuring by laser diffraction, for example, particles to be measured may be dispersed in a dispersion medium, irradiated with approximately 28 kHz ultrasonic waves at an output of 60 W by introducing the dispersion medium into a commercially available laser diffraction particle size measuring device (e.g., Microtrac MT 3000), and D100 may be calculated based on 100% of the particle size distribution using the measuring device.

In this specification, ‘particle diameter D50’ refers to the particle diameter of a particle having a cumulative volume of 50% by volume in a particle size distribution. The particle size distribution can be obtained by referring to the method described in the above ‘particle diameter D100’.

If (when) the above particle is spherical, the above size may mean the diameter.

In the specification, “(meth)acryl” means acryl and/or methacryl.

Unless otherwise defined below, “substitution” refers to substituting hydrogen of a compound with a substituent such as or including at least one of a C1 to C30 alkyl group, a C2 to C30 alkenyl group, a C2 to C30 alkynyl group, a C6 to C30 aryl group, a C7 to C30 alkylaryl group, a C1 to C30 alkoxy group, a C1 to C30 heteroalkyl group, a C3 to C30 heteroalkylaryl group, a C3 to C30 cycloalkyl group, a C3 to C15 cycloalkenyl group, a C6 to C30 cycloalkynyl group, a C2 to C30 heterocycloalkyl group, a halogen (F, Cl, Br, or I), a hydroxyl group (—OH), a nitro group (—NO₂), a cyano group (—CN), an amino group (—NRR′) (here, R and R′ are each independently hydrogen or a C1 to C6 alkyl group), a sulfobetaine group (—RR′N⁺ (CH₂)ₙSO—, n is a natural number from 1 to 10), a carboxybetaine group (—RR′N⁺ (CH₂)ₙCOO⁻, n is a natural number from 1 to 10) (here, R and R′ are each independently a C1 to C20 alkyl group), an azido group (—N₃), an amidino group (—C(═NH)NH₂), a hydrazine group (—NHNH₂), a hydrazono group (═N(NH₂), a carbamoyl group (—C(O)NH₂), a thiol group (—SH), an acyl group (—C(═O)R, and here, R is hydrogen, a C1 to C6 alkyl group, a C1 to C6 alkoxy group, or a C6 to C12 aryl group), a carboxyl group (—COOH) or a salt thereof (—C(═O)OM, and here, M is an organic or inorganic cation), a sulfonic acid group (—SO₃H) or a salt thereof (—SO₃M, and here, M is an organic or inorganic cation), a phosphoric acid group (—PO₃H₂) or a salt thereof (—PO₃ MH or —PO₃M₂, and here, M is an organic or inorganic cation), and a combination thereof.

The C₁ to C₃ alkyl group below is a methyl group, an ethyl group, or a propyl group. The C1 to C10 alkylene group may be, for example, a C1 to C6 alkylene group, a C1 to C5 alkylene group, or a C1 to C3 alkylene group, such as a methylene group, an ethylene group, or a propylene group. The C3 to C20 cycloalkylene group may be, for example, a C3 to C10 cycloalkylene group, or a C5 to C10 cycloalkylene group, such as a cyclohexylene group. The C6 to C20 arylene group may be, for example, a C6 to C10 arylene group, such as a phenylene group. The C3 to C20 heterocyclic group may be, for example, a C3 to C10 heterocyclic group, such as a pyridinyl group.

“Hetero” used herein refers inclusion of one or more hetero atoms such as or including at least one of N, O, S, Si, and P.

In chemical formulas, the symbol “*” indicates a moiety that is connected to the same or different atoms, groups, or structural units. Unless specifically stated otherwise in a chemical formula shown herein, it may be assumed that hydrogen is bonded in the structure of the chemical formula.

“Alkali metal” used herein refers to an element belonging to Group 1 of the periodic table, such as, e.g., lithium, sodium, potassium, rubidium, cesium, or francium, which may be present in a cationic or neutral state.

When specifying a numerical range in the specification, “X to Y” means “X or more and Y or less (X≤and ≤Y).”

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

Hereinafter, the separator for a rechargeable battery, and a rechargeable battery including the separator of the present disclosure are described in detail.

### Separator for Rechargeable Lithium Battery According to One Example Embodiment

According to one example embodiment, a separator for a rechargeable battery of the present disclosure may have high substrate adhesion to reduce or prevent separation between a first layer and a porous substrate. The separator may provide improved air permeability and a low heat shrinkage rate as well as high substrate adhesion, thereby increasing the lifetime and safety of a battery.

According to one example embodiment, the separator may have a substrate adhesion of about 0.4 N/12 mm or more, for example, about 0.7 N/12 mm or more.

According to one example embodiment, the separator may have a dry heat shrinkage rate of about 5% or less, for example, about 3% or less in each of a machine direction and a transverse direction.

According to one example embodiment, the separator may have an air permeability of about 150 sec/100 cc or less.

The separator for a rechargeable lithium battery includes a porous substrate, and a first layer located on at least one surface of the porous substrate. The first layer includes a binder and a filler, the binder includes a mixture of a first binder and a second binder, the second binder is an adhesive binder, and the filler includes a mixture of cellulose-based nanofibers with a carboxyl group or carboxylate, cellulose-based nanocrystals with a carboxyl group or carboxylate, and a filler that is not surface-modified.

The first layer may be formed of or include a composition for a first layer, which includes the binder and the filler.

Hereinafter, the configuration of the separator is described in detail.

### First Layer

The first layer may be or include a heat-resistant coating layer. Also, the first layer may be or include an adhesive coating layer.

### Binder

The binder includes a mixture of a first binder and a second binder. The mixture of the first binder and the second binder may be included at about 95 wt % or more, for example, in a range of about 95 wt % to about 100 wt %, or 100 wt % of the binder.

The second binder is an adhesive binder. The second binder includes one or more of polyvinyl alcohol, polyacrylic acid, and poly(vinyl alcohol-co-acrylic acid). One or more of polyvinyl alcohol, polyacrylic acid, and poly(vinyl alcohol-co-acrylic acid) may increase the adhesion between the first binder and the filler that is not surface-modified.

According to one example embodiment, the second binder may have a glass transition temperature in a range of about −20° C. to about 30° C., for example, −20, −19, −18, −17, −16, −15, −14, −13, −12, −11, −10, −9, −8, −7, −6, −5, −4, −3, −2, −1, 0, 1, 2, 3, 4, 5, 6, 7, 8, 9, 10, 11, 12, 13, 14, 15, 16, 17, 18, 19, 20° C., −10° C. to 20° C. In the above range, the second binder is advantageous in providing high adhesive strength and high substrate adhesion, which have been mentioned above, and may not increase the air permeability of the separator. The glass transition temperature may be measured using, e.g., a differential scanning calorimeter (DSC).

According to one example embodiment, the second binder may have a weight average molecular weight in a range of about 100,000 g/mol to about 800,000 g/mol, for example, 100,000, 200,000, 300,000, 400,000, 500,000, 600,000, 700,000, 800,000 g/mol, 200,000 g/mol to 500,000 g/mol. In the above range, the second binder is advantageous in providing the above-described adhesion, and may not increase air permeability.

The weight average molecular weight may be obtained by polystyrene conversion using, e.g., gel permeation chromatography.

The second binder may be included in a range of about 10 parts by weight to about 25 parts by weight, for example 10, 11, 12, 13, 14, 15, 16, 17, 18, 19, 20, 21, 22, 23, 24, 25 parts by weight based on 100 parts by weight of the total of the first binder and the second binder. In the above range, it may be possible to provide high substrate adhesion.

As the first binder is a non-adhesive binder, the first binder may contribute to lowering the heat shrinkage rate of the separator due to having high heat resistance. The first binder may be an aqueous heat-resistant binder.

The first binder may be included in a range of about 75 parts by weight to about 90 parts by weight, for example 75, 76, 77, 78, 79, 80, 81, 82, 83, 84, 85, 86, 87, 88, 89, 90 parts by weight based on 100 parts by weight of the total of the first binder and the second binder. In the above range, the first binder is advantageous in increasing substrate adhesion and lowering the heat shrinkage rate.

The first binder includes a (meth)acrylic binder containing a structural unit containing a sulfonate group. The (meth)acrylic binder containing a structural unit containing a sulfonate group may be advantageous in improving heat resistance and reducing membrane resistance when included in the first layer along with the mixture.

The structural unit containing a sulfonate group may be included in a range of about 0.1 mol % to about 65 mol %, for example, about 0.1 mol % to about 60 mol %, 0.1 mol % to 20 mol %, 0.1 mol % to 10 mol %, 1 mol % to 20 mol %, 1 mol % to 10 mol %, 20 mol % to 65 mol %, or 30 mol % to 65 mol % of the (meth)acrylic binder. When the structural unit containing a sulfonate group is included in the above range, the (meth)acrylic binder and a separator including the (meth)acrylic binder may exhibit desired or improved adhesive strength, heat resistance, air permeability, and oxidation resistance.

The (meth)acrylic binder may further include one or more of a structural unit derived from (meth)acrylate or (meth)acrylic acid, a structural unit containing a cyano group, and a structural unit derived from (meth)acryl amide.

The structural unit derived from (meth)acrylate or (meth)acrylic acid may be included in a range of about 0 mol % to about 70 mol %, for example, 10 mol % to 70 mol %, 10 mol % to 60 mol %, 20 mol % to 60 mol %, 10 mol % to 50 mol %, 30 mol % to 60 mol %, 10 mol % to 40 mol %, or 40 mol % to 55 mol % of the (meth)acrylic binder. When the structural unit derived from (meth)acrylate or (meth)acrylic acid is included in the above range, a separator including the (meth)acrylic binder may exhibit desired or improved adhesive strength, heat resistance, air permeability and oxidation resistance.

The structural unit containing a cyano group may be included in a range of about 0 mol % to about 85 mol %, for example, 30 mol % to 85 mol %, 30 mol % to 70 mol %, 30 mol % to 60 mol %, 35 mol % to 60 mol %, or 35 mol % to 55 mol % of the (meth)acrylic binder. When the structural unit containing a cyano group is included within the above range, the (meth)acrylic binder and a separator including the cyano group may ensure desired or improved oxidation resistance and exhibit desired or improved adhesive strength, heat resistance, and air permeability.

The structural unit derived from (meth)acryl amide may be included in a range of about 0 mol % to about 95 mol %, for example, 40 mol % to 85 mol %, 50 mol % to 85 mol %, 55 mol % to 95 mol %, 60 mol % to 85 mol %, 75 mol % to 95 mol %, or 80 mol % to 95 mol % of the (meth)acrylic binder. When the structural unit derived from (meth)acryl amide is included within the above range, the (meth)acrylic binder and a separator including the (meth)acrylic binder may ensure desired or improved oxidation resistance and exhibit desired or improved adhesive strength, heat resistance, and air permeability.

According to one example embodiment, the (meth)acrylic binder may have a structural unit containing a sulfonate group, a structural unit derived from (meth)acrylate or (meth)acrylic acid, and a structural unit containing a cyano group (referred to as binder 1). In one example embodiment, the total of the structural unit containing a sulfonate group, a structural unit derived from (meth)acrylate or (meth)acrylic acid, and a structural unit containing a cyano group may be included at about 95 mol % or more, for example, a range of about 95 mol % to about 100 mol %, or 100 mol % based on 100 mol % of the (meth)acrylic binder.

According to another example embodiment, the (meth)acrylic binder may have a structural unit containing a sulfonate group, and a structural unit derived from (meth)acryl amide (referred to as binder 2). In one example embodiment, the total of the structural unit containing a sulfonate group and the structural unit derived from (meth)acryl amide may be included at about 95 mol % or more, for example, a range of about 95 mol % to about 100 mol %, or 100 mol %, based on 100 mol % of the (meth)acrylic binder.

According to still another example embodiment, the (meth)acrylic binder may have a structural unit containing a sulfonate group, a structural unit derived from (meth)acrylate or (meth)acrylic acid, and a structural unit derived from (meth)acryl amide (referred to as binder 3). In one example embodiment, the total of the structural unit containing a sulfonate group, the structural unit derived from (meth)acrylate or (meth)acrylic acid, and the structural unit derived from (meth)acryl amide may be included at about 95 mol % or more, for example, a range of about 95 mol % to about 100 mol %, or 100 mol %, based on 100 mol % of the (meth)acrylic binder.

For example, the (meth)acrylic binder may be binder 2 or binder 3. Binder 2 or binder 3 may have desired or improved effects in improving membrane resistance and heat resistance.

Each structural unit of the (meth)acrylic binder is described in detail below.

The structural unit derived from (meth)acrylate or (meth)acrylic acid may be represented by, for example, at least one of Chemical Formula 1 below, Chemical Formula 2 below, Chemical Formula 3 below, or a combination thereof:

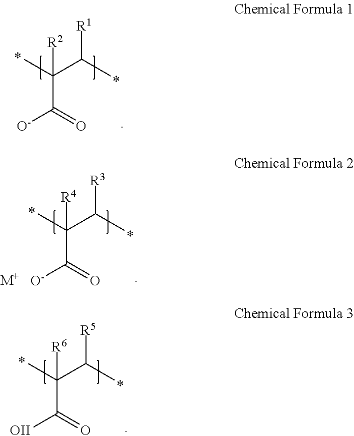

In Chemical Formulas 1 to 3,
R¹ to R⁶ each independently is or includes hydrogen or a methyl group, and
in Chemical Formula 2,
M is or includes an alkali metal.

The alkali metal may be or include, for example, at least one of lithium, sodium, potassium, rubidium, or cesium.

For example, the structural unit derived from (meth)acrylate or (meth)acrylic acid may include a structural unit represented by Chemical Formula 2, and a structural unit represented by Chemical Formula 3. In this case, the structural unit represented by Chemical Formula 2 and the structural unit represented by Chemical Formula 3 may be included at a molar ratio in a range of about 10:1 to about 1:2, 10:1 to 1:1, or 5:1 to 1:1.

The structural unit containing a cyano group may be represented by, for example, Chemical Formula 4 below.

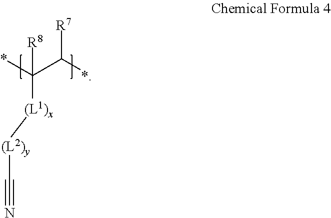

In Chemical Formula 4,
R⁷ and R⁸ each independently is or includes hydrogen or a C1 to C3 alkyl group,
L¹ is or includes —C(═O)—, —C(═O)O—, —OC(═O)—, —O—, or —C(═O)NH—,
x is an integer ranging from 0 to 2,
L² is or includes a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group, and
y is an integer ranging from 0 to 2.

The structural unit containing a cyano group may be or include, for example, a structural unit derived from (meth)acrylonitrile, alkene nitrile, cyanoalkyl(meth)acrylate, or 2-(vinyloxy)alkane nitrile. Here, the alkene may be a C2 to C20 alkene, a C2 to C10 alkene, or a C2 to C6 alkene, the alkyl may be a C1 to C20 alkyl, a C1 to C10 alkyl, or a C1 to C6 alkyl, and the alkane may be a C1 to C20 alkane, a C1 to C10 alkane, or a C1 to C6 alkane.

The alkene nitrile may be or include, for example, allyl cyanide, 4-pentene nitrile, 3-pentene nitrile, 2-pentene nitrile, or 5-hexene nitrile. The cyanoalkyl(meth)acrylate may be or include, for example, cyanomethyl (meth)acrylate, cyanoethyl (meth)acrylate, cyanopropyl (meth)acrylate, or cyanooctyl (meth)acrylate. The 2-(vinyloxy)alkane nitrile may be or include, for example, 2-(vinyloxy)ethanenitrile, or 2-(vinyloxy)propanenitrile.

The structural unit containing a sulfonate group may be or include a structural unit containing a conjugate base of sulfonic acid, sulfonate, sulfonic ester, or a derivative thereof. For example, the structural unit containing a sulfonate group may be represented by at least one of Chemical Formula 5 below, Chemical Formula 6 below, Chemical Formula 7 below, or a combination thereof.

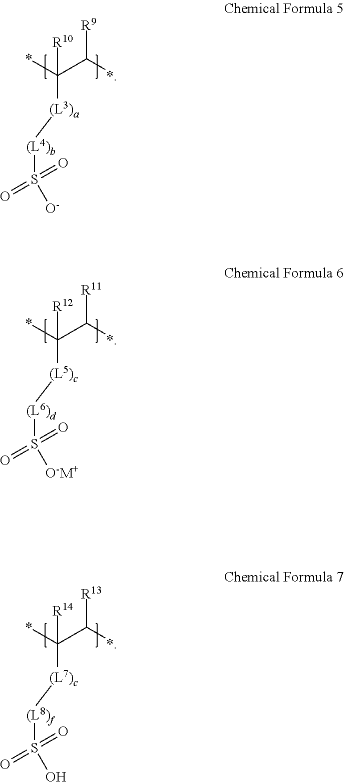

In Chemical Formulas 5 to 7,
R⁹ to R¹⁴ each independently is or includes hydrogen or a C1 to C3 alkyl group,
L³, L⁵, and L⁷ each independently is or includes —C(═O)—, —C(═O)O—, —OC(═O)—, —O—, or —C(═O)NH—,
L⁴, L⁶, and L⁸ each independently is or includes a substituted or unsubstituted C1 to C10 alkylene group, a substituted or unsubstituted C3 to C20 cycloalkylene group, a substituted or unsubstituted C6 to C20 arylene group, or a substituted or unsubstituted C3 to C20 heterocyclic group,
a, b, c, d, e, and f are each independently an integer ranging from 0 to 2, and
in Chemical Formula 6,
M is or includes an alkali metal.

For example, in Chemical Formulas 5 to 7,
L³, L⁵, and L⁷ may each independently be or include —C(═O)NH—,
L⁴, L⁶, and L⁸ may each independently be or include a C1 to C10 alkylene group, and
a, b, c, d, e, and f may each be an integer equal to 1.

The structural unit containing a sulfonate group may include any one, or at least two of a structural unit represented by Chemical Formula 5, a structural unit represented by Chemical Formula 6, and a structural unit represented by Chemical Formula 7. In one example, the structural unit containing a sulfonate group may include a structural unit represented by Chemical Formula 6, and in another example, the structural unit containing a sulfonate group may include a structural unit represented by Chemical Formula 6, and a structural unit represented by Chemical Formula 7.

The structural unit containing a sulfonate group may be or include, for example, a structural unit derived from vinyl sulfonic acid, allyl sulfonic acid, styrene sulfonic acid, anethole sulfonic acid, (meth)acrylamidoalkane sulfonic acid, sulfoalkyl (meth)acrylate or a salt thereof. Here, the alkane may be a C1 to C20 alkane, a C1 to C10 alkane, or a C1 to C6 alkane, and the alkyl may be a C1 to C20 alkyl, a C1 to C10 alkyl, or a C1 to C6 alkyl. The salt refers to a salt formed of or including the above-described sulfonic acid and a desired ion. The ion may be or include, for example, an alkali metal ion, and in this case, the salt may be or include a sulfonic acid alkali metal salt.

The (meth)acrylamidoalkane sulfonic acid may be or include, for example, 2-(meth)acrylamido-2-methylpropane sulfonic acid, and the sulfoalkyl (meth)acrylate may be or include, for example, 2-sulfoethyl (meth)acrylate, or 3-sulfopropyl (meth)acrylate.

The structural unit derived from (meth)acryl amide may be represented by Chemical Formula 8 below.

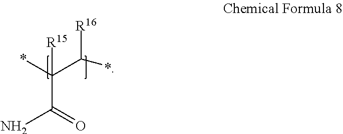

In Chemical Formula 8,
R¹⁵ and R¹⁶ each independently is or includes hydrogen or a methyl group.

The (meth)acrylic binder may include an alkali metal. The alkali metal may be present in the form of a cation, for example, lithium, sodium, potassium, rubidium, or cesium. For example, the alkali metal may be combined with the (meth)acrylic binder and present in the form of a salt. The alkali metal may assist the synthesis of the (meth)acrylic binder in an aqueous solvent, improve the adhesive strength of the first layer, and improve the heat resistance, air permeability, and oxidation resistance of a separator.

The alkali metal may be included in the (meth)acrylic binder in a range of about 1 wt % to about 40 wt %, for example, 1 wt % to 30 wt %, 1 wt % to 20 wt %, or 10 wt % to 20 wt %. For example, the weight ratio of the (meth)acrylic binder and the alkali metal may be in a range of about 99:1 to about 60:40, 99:1 to 70:30, 99:1 to 80:20, or 90:10 to 80:20.

In addition, the alkali metal may be included in a range of about 0.1 mol % to about 1.0 mol % based on the total content of the alkali metal and the (meth)acrylic binder. When the alkali metal is included within the above range, the first layer may have desired or improved adhesive strength, and a separator including the alkali metal may exhibit desired or improved heat resistance, air permeability and oxidation resistance.

The (meth)acrylic binder may be present in various forms such as an alternating polymer in which the structural units are alternately distributed, a random polymer in which the structural units are randomly distributed, and a graft polymer in which some structural units are grafted.

The weight average molecular weight (Mw) of the (meth)acrylic binder may be in a range of about 200,000 g/mol to about 700,000 g/mol, for example, 200,000 g/mol to 600,000 g/mol, or 300,000 g/mol to 600,000 g/mol. When the weight average molecular weight (Mw) of the (meth)acrylic binder satisfies the above range, the (meth)acrylic binder and a separator including the (meth)acrylic binder may exhibit desired or improved adhesive strength, heat resistance, air permeability and oxidation resistance. The weight average molecular weight may be a polystyrene-converted average molecular weight, which is measured using gel permeation chromatography.

The glass transition temperature of the (meth)acrylic binder may be in a range of about 200° C. to about 280° C., 210° C. to 270° C., or 210° C. to 260° C. When the glass transition temperature of the (meth)acrylic binder satisfies the above range, the (meth)acrylic binder, and a separator including the (meth)acrylic binder, may exhibit desired or improved adhesive strength, heat resistance, air permeability and oxidation resistance. The glass transition temperature may be measured by, e.g., differential scanning calorimetry.

The (meth)acrylic binder may have a melting point (Tm) of about 160° C. or more.

The (meth)acrylic binder may be prepared by a solution polymerization method.

According to one example embodiment, the (meth)acrylic binder may be included in the first layer of a separator in the form of a film.

The first layer includes a mixture of cellulose-based nanofibers having a carboxyl group or carboxylate and cellulose-based nanocrystals having a carboxyl group or carboxylate. When the content of the second binder in the mixture of the first binder and the second binder is increased to raise substrate adhesion, the separator may ensure both high substrate adhesion and improved air permeability by resolving the problem of the air permeability of the separator increasing.

Here, the carboxyl group may refer to —COOH(a carboxylic acid), and the carboxylate may refer to —COO⁻ M⁺ (M is or includes an alkali metal).

A first layer that includes only cellulose-based nanocrystals having a carboxyl group or carboxylate without cellulose-based nanofibers having a carboxyl group or carboxylate may improve substrate adhesion, but may present a challenge of the air permeability of the separator greatly increasing.

In a first layer including only cellulose-based nanofibers having a carboxyl group or carboxylate without cellulose-based nanocrystals having a carboxyl group or carboxylate, nanofiber agglomeration may occur, causing limited improvement in substrate adhesion and a great increase in the air permeability of the separator.

According to one example embodiment, the mixture of cellulose-based nanofibers having a carboxyl group or carboxylate and cellulose-based nanocrystals having a carboxyl group or carboxylate may be included in a range of about 0.1 parts by weight to about 0.5 parts by weight, for example, 0.1, 0.15, 0.2, 0.25, 0.3, 0.35, 0.4, 0.45, 0.5 parts by weight, 0.1 parts by weight to 0.3 parts by weight, based on 100 parts by weight of the mixture of the first binder and the second binder. Within the above range, the mixture of cellulose-based nanofibers having a carboxyl group or carboxylate and cellulose-based nanocrystals having a carboxyl group or carboxylate may not affect the effects of the filler that has not been surface-modified, but provide the effect of improving substrate adhesion and air permeability.

According to one example embodiment, the weight ratio of the cellulose-based nanofibers having a carboxyl group or carboxylate: the cellulose-based nanocrystals having a carboxyl group or carboxylate may be in a range of about 1:0.1 to about 1:5, for example, 1:0.1, 1:0.2, 1:0.3, 1:0.4, 1:0.5, 1:0.6, 1:0.7, 1:0.8, 1:0.9, 1:1, 1:1.1, 1:1.2, 1:1.3, 1:1.4, 1:1.5, 1:1.6, 1:1.7, 1:1.8, 1:1.9, 1:2, 1:2.1, 1:2.2, 1:2.3, 1:2.4, 1:2.5, 1:2.6, 1:2.7, 1:2.8, 1:2.9, 1:3, 1:3.1, 1:3.2, 1:3.3, 1:3.4, 1:3.5, 1:3.6, 1:3.7, 1:3.8, 1:3.9, 1:4, 1:4.1, 1:4.2, 1:4.3, 1:4.4, 1:4.5, 1:4.6, 1:4.7, 1:4.8, 1:4.9, 1:5, 1:0.3 to 1:3, in the first layer. Within the above range, the balance between increased substrate adhesion and low air permeability may be adjusted.

### Cellulose-Based Nanofibers Having Carboxyl Group or Carboxylate

The cellulose-based nanofibers having a carboxyl group or carboxylate may reduce the amount of the second binder used by increasing substrate adhesion, thereby reducing or preventing an increase in air permeability of the separator.

The cellulose-based nanofibers having a carboxyl group or carboxylate has a carboxyl group or carboxylate on the outermost surface. The cellulose-based nanofibers having a carboxyl group or carboxylate may be prepared by surface-modifying unmodified cellulose-based nanofibers to have a carboxyl group or carboxylate.

The cellulose-based nanofibers that are not surface-modified have hydroxyl groups in their molecules. The surface modification may be performed by oxidizing the cellulose-based nanofibers with an oxidizing agent. The oxidizing agent may include, for example, 2,2,6,6-tetramethylpiperidine-1-oxyl radical (TEMPO), but the present disclosure is not limited thereto.

According to one example embodiment, the cellulose-based nanofibers having a carboxyl group or carboxylate may have a carboxyl group or carboxylate linked to C6 in the cellulose unit.

According to one example embodiment, the cellulose-based nanofibers having a carboxyl group or carboxylate may have a maximum diameter in a range of about 3 nm to about 4 nm and a maximum length of about 1 m or more, for example, a range of about 1 m to about 10 m. Within the above ranges, the cellulose-based nanofibers may exhibit a heat shrinkage-improving effect in an electrolyte.

The cellulose-based nanofibers having a carboxyl group or carboxylate may be included in a range of about 0.01 parts by weight to about 0.5 parts by weight, for example 0.01, 0.05, 0.1, 00.15, 0.2, 0.25, 0.3, 0.35, 0.4, 0.45, 0.5 parts by weight, 0.05 parts by weight to 0.2 parts by weight, or 0.05 parts by weight to 0.15 parts by weight based on 100 parts by weight of the binder, that is, the mixture of the first binder and the second binder. Within the above range, the cellulose-based nanofibers having a carboxyl group or carboxylate may provide improved air permeability and a low heat shrinkage rate.

### Cellulose-Based Nanocrystals Having Carboxyl Group or Carboxylate

The cellulose-based nanocrystals having a carboxyl group or carboxylate may reduce the amount of the above-described second binder used by increasing substrate adhesion, thereby reducing or preventing an increase in the air permeability of the separator.

The cellulose-based nanocrystals having a carboxyl group or carboxylate has a carboxyl group or carboxylate on the outermost surface thereof. The cellulose-based nanocrystals having a carboxyl group or carboxylate may be surface-modified to have a carboxyl group or carboxylate.

Cellulose-based nanocrystals that are not surface-modified have hydroxyl groups in their molecules. The surface modification may be performed by oxidizing the cellulose-based nanocrystals using an oxidizing agent. The oxidizing agent may include, for example, TEMPO, but the present disclosure is not limited thereto.

According to one example embodiment, the cellulose-based nanocrystals having a carboxyl group or carboxylate may have a carboxyl group or carboxylate linked to C6 in the cellulose unit.

According to one example embodiment, the cellulose-based nanocrystals having a carboxyl group or carboxylate may have a maximum width in a range of about 5 nm to about 20 nm and a maximum length in a range of about 100 nm to about 250 nm. Within the above range, the cellulose-based nanocrystals may exhibit a heat shrinkage-improving effect in an electrolyte.

The cellulose-based nanocrystals having a carboxyl group or carboxylate may be included at 0.01 parts by weight to 0.5 parts by weight, for example 0.01, 0.05, 0.1, 00.15, 0.2, 0.25, 0.3, 0.35, 0.4, 0.45, 0.5 parts by weight, 0.05 parts by weight to 0.2 parts by weight, or 0.05 parts by weight to 0.15 parts by weight based on 100 parts by weight of the binder, that is, the mixture of the first binder and the second binder. Within the above range, the cellulose-based nanocrystals may provide improved air permeability and a low heat shrinkage rate.

The first layer includes a filler that is not surface-modified. A first layer that includes the mixture of cellulose-based nanofibers having a carboxyl group or carboxylate and cellulose-based nanocrystals having a carboxyl group or carboxylate without the filler that is not surface-modified may have an increased heat shrinkage rate.

Filler that is not Surface-Modified

A filler that is not surface-modified (non-surface-modified filler) may be or include an inorganic filler, an organic filler, an organic/inorganic composite filler or a combination thereof. The inorganic filler may be or include a ceramic material that can improve heat resistance. The inorganic filler may include, for example, at least one of a metal oxide, a metalloid oxide, a metal fluoride, a metal hydroxide, or a combination thereof. The inorganic filler may include, for example, at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but the present disclosure is not limited thereto. The organic filler may include at least one of an acryl compound, an imide compound, an amide compound, or a combination thereof, but the present disclosure is not limited thereto. The organic filler may have a core-shell structure, but the present disclosure is not limited thereto. For example, the filler may be boehmite.

The filler may be spherical, plate-like, cubic, or amorphous. For example, the filler may be or include a plate-like filler. The plate-like filler may readily ensure the effects of the separator.

The filler has to be included at a desired content with respect to the binder, for example, the mixture of the first binder and the second binder. According to one example embodiment, the mixture of the first binder and the second binder and the filler may be included in a mass ratio in a range of about 1:10 to about 1:50, for example, 1:10, 1:11, 1:12, 1:13, 1:14, 1:15, 1:16, 1:17, 1:18, 1:19, 1:20, 1:21, 1:22, 1:23, 1:24, 1:25, 1:26, 1:27, 1:28, 1:29, 1:30, 1:31, 1:32, 1:33, 1:34, 1:35, 1:36, 1:37, 1:38, 1:39, 1:40, 1:41, 1:42, 1:43, 1:44, 1:45, 1:46, 1:47, 1:48, 1:49, 1:50, 1:10 to 1:30, or 1:20 to 1:30. Within the above range, the mixture may have a heat shrinkage-improving effect in an electrolyte.

The filler may have a particle diameter (D100) of about 1.0 m or less. Within the above range, the filler may readily reach the dry shrinkage rate. For example, the filler may have a particle diameter (D100) of 0.1, 0.2, 0.3, 0.4, 0.5, 0.6, 0.7, 0.8, 0.9, 1.0 m, about 0.5 m or less, or in a range of about 0.3 μm to about 0.5 m.

The filler may have a particle diameter (D50) of about 0.4 m or less, about 0.3 m or less, or in a range of about 0.2 m to about 0.3 m. Within the above range, the filler may exhibit a heat shrinkage-improving effect in an electrolyte.

The filler may be included in a range of about 50 wt % to about 99 wt %, 70 wt % to 99 wt %, 75 wt % to 99 wt %, 80 wt % to 99 wt %, 85 wt % to 99 wt %, 90 wt % to 99 wt %, or 95 wt % to 99 wt % based on the total weight of the first layer. When the filler is included within the above range, the filler may exhibit desired or improved heat resistance, durability, oxidation resistance, and stability.

The first layer may be formed by coating at least one surface of a porous substrate to be described below with the composition for a first layer and drying the composition.

Each first layer may have a thickness in a range of about 0.01 μm to about 20 μm, and within the above range, each first layer may have a thickness in a range of about 0.1 μm to about 10 μm, 0.5 μm to 5 μm, or 0.5 μm to 3 μm.

The ratio of the thickness of the first layer to the thickness of the porous substrate may be, for example, in a range of about 0.05 to about 0.4, 0.05 to 0.3, or 0.1 to 0.2. Within the above range, the separator may exhibit desired or improved air permeability, heat resistance and adhesive strength. Here, the “thickness of the first layer” refers to the thickness of one first layer when the first layer is formed on only one surface of the porous substrate, and the thickness of two first layers when the first layer is formed on both surfaces of the porous substrate.

### Porous Substrate

A porous substrate has a large number of pores and may be or include a substrate commonly used in electrochemical devices. The porous substrate may be or include, but is not limited to, a polymer film which is formed of or include any one polymer such as or including at least one of polyolefins such as polyethylene and polypropylene, polyesters such as polyethylene terephthalate and polybutylene terephthalate, polyacetal, polyamide, polyimide, polycarbonate, polyetheretherketone, polyaryletherketone, polyetherimide, polyamideimide, polybenzimidazole, polyethersulfone, polyphenylene oxide, cyclic olefin copolymers, polyphenylene sulfide, polyethylene naphthalate, glass fiber, Teflon, and polytetrafluoroethylene, or a copolymer or mixture of two or more thereof.

The porous substrate may be or include, for example, a polyolefin-based substrate including a polyolefin, and the polyolefin-based substrate may have a desired or improved shutdown function, thereby contributing to improving the safety of the battery. The polyolefin-based substrate may be or include, for example, at least one of a polyethylene single layer film, a polypropylene single-layer film, a polyethylene/polypropylene two-layer film, a polypropylene/polyethylene/polypropylene three-layer film, and a polyethylene/polypropylene/polyethylene three-layer film. In addition, the polyolefin-based resin may include a non-olefin resin in addition to an olefin resin, or may include a copolymer of olefin and non-olefin monomers.

The porous substrate may have a thickness in a range of about 1 μm to about 40 μm, for example, 1 μm to 30 μm, 1 μm to 20 μm, or 5 μm to 15 μm.

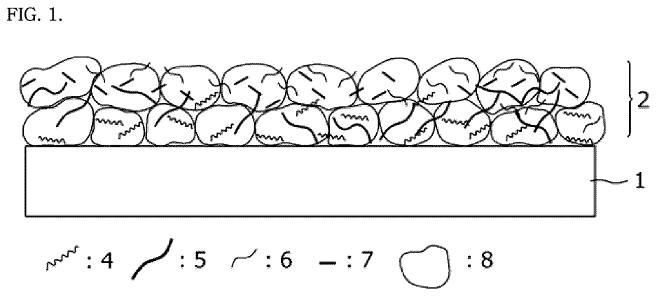

FIG. 1 is a cross-sectional view illustrating a separator for a rechargeable lithium battery, according to one example embodiment.

Referring to FIG. 1, the separator for a rechargeable lithium battery includes a porous substrate 1, and a first layer 2 located on one surface of the porous substrate 1. The first layer 2 may include a first binder 4, a second binder 5, a cellulose-based nanofiber having a carboxyl group 6, a cellulose-based nanocrystal having a carboxyl group 7, and a filler that is not surface-modified 8.

FIG. 1 shows a separator in which the first layer 2 is located on only one surface of the porous substrate 1. A separator in which first layers 2 are located on both surfaces of the porous substrate 1 may also be included within the scope of the present disclosure.

In the separator for a rechargeable lithium battery, a second layer described below may be further stacked on the first layer. Therefore, a separator for a rechargeable lithium battery, in which a first layer and a second layer are located, e.g., sequentially located, on at least one surface of a porous substrate, is described below.

### Separator for Rechargeable Lithium Battery According to Another Example Embodiment

According to another example embodiment, the separator for a rechargeable lithium battery of the present disclosure may have high substrate adhesion to reduce or prevent separation between a first layer and a porous substrate. The separator may have high substrate adhesion and also provide improved air permeability and a low heat shrinkage rate. The separator may have high dry adhesion and wet adhesion to each of a positive electrode and a negative electrode.

According to one example embodiment, the separator may have a substrate adhesion of about 0.4N/12 mm or more.

According to one example embodiment, the separator may have a dry heat shrinkage rate in a machine direction (MD) or a transverse direction (TD) of about 5% or less.

According to one example embodiment, the separator may have an air permeability of about 150 sec/100 cc or less.

According to one example embodiment, the separator may have a dry adhesion to a positive or negative electrode of about 0.5 gf/mm or more.

According to one example embodiment, the separator may have a wet adhesion to a positive or negative electrode of about 0.5 gf/mm or more.

The separator includes a porous substrate, a first layer and a second layer which are located, e.g., sequentially located, on at least one surface of the porous substrate, the first layer includes a binder and a filler, the binder includes a mixture of a first binder and a second binder, the second binder is an adhesive binder, the second binder includes one or more of polyvinyl alcohol, polyacrylic acid, and poly(vinyl alcohol-co-acrylic acid), the filler includes a mixture of cellulose-based nanofibers with a carboxyl group or carboxylate, cellulose-based nanocrystals with a carboxyl group or carboxylate, and a filler that is not surface-modified, and the second layer is an adhesive layer.

The first layer may be formed of or include a composition for a first layer, which includes the binder and the filler.

### First Layer

The first layer may be or include a heat-resistant adhesive layer.

In one example embodiment, the first layer may be substantially the same as the first layer described for the separator according to the above example embodiment.

The first layer includes a binder and a filler, the binder includes a first binder and a second binder, the second binder is an adhesive binder, the second binder includes one or more of polyvinyl alcohol, polyacrylic acid, and poly(vinyl alcohol-co-acrylic acid), the filler includes a mixture of cellulose-based nanofibers with a carboxyl group or carboxylate, cellulose-based nanocrystals with a carboxyl group or carboxylate, and a filler that is not surface-modified.

The first binder may be substantially the same as the first binder described in the above example embodiment.

The second binder may be substantially the same as the second binder described in the above example embodiment.

The cellulose-based nanofibers with a carboxyl group or carboxylate may be substantially the same as cellulose-based nanofibers with a carboxyl group or carboxylate, which is described for the separator according to the above example embodiment.

The filler that is not surface-modified may be substantially the same as the filler not surface-modified, which is described for the separator according to the above example embodiment.

Therefore, the detailed description of the first layer is omitted.

### Second Layer

The second layer is an adhesive layer. The second layer may include one or more of an acrylic adhesive binder and a polyvinylidene fluoride-based adhesive binder as an adhesive binder.

The acrylic adhesive binder may be or include a crosslinked polymethacrylate-based binder, but the present disclosure is not limited thereto.

The polyvinylidene fluoride-based adhesive binder may be or include a crosslinked polymer such as or including at least one of a homopolymer including only a vinylidene fluoride monomer-derived structural unit, and a copolymer of a vinylidene fluoride-derived structural unit and a structural unit derived from another monomer.

The copolymer may include, for example, a vinylidene fluoride-derived structural unit, and one or more structural units derived from chlorotrifluoroethylene, trifluoroethylene, hexafluoropropylene, ethylene tetrafluoride, and an ethylene monomer, but the present disclosure is not limited thereto. For example, the copolymer may be or include a polyvinylidene fluoride-hexfluoropropylene (PVdF-HFP) copolymer including a vinylidene fluoride monomer-derived structural unit and a hexafluoropropylene monomer-derived structural unit.

The second layer may further include the above-described second binder, in addition to the adhesive binder. Therefore, the dry adhesion and wet adhesion to a positive or negative electrode of the separator may be improved.

According to one example embodiment, the second binder and the adhesive binder may be included at a mass ratio in a range of about 1:5 to about 1:20, for example, 1:5, 1:6, 1:7, 1:8, 1:9, 1:10, 1:11, 1:12, 1:13, 1:14, 1:15, 1:16, 1:17, 1:18, 1:19, 1:20, 1:5 to 1:10.

The second layer may have a thickness in a range of about 0.01 μm to about 20 μm, and within the above range, may have a thickness in a range of about 0.1 μm to about 10 μm, 0.1 μm to 5 μm, or 0.1 μm to 3 μm.

### Porous Substrate

The porous substrate may be substantially the same as the porous substrate according to the example embodiment described above. Therefore, the detailed description of the porous substrate is omitted.

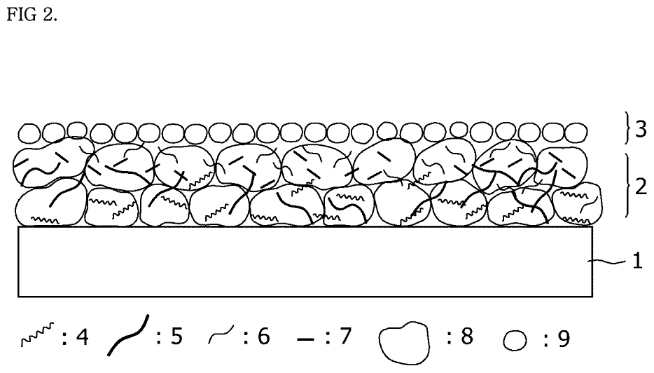

FIG. 2 is a cross-sectional view illustrating a separator for a rechargeable lithium battery according to another example embodiment.

Referring to FIG. 2, the separator for a rechargeable lithium battery includes a porous substrate 1, a first layer 2 and a second layer 3, which are located on one surface of the porous substrate 1. The first layer 2 includes a first binder 4, a second binder 5, cellulose-based nanofibers 6 with a carboxyl group, cellulose-based nanocrystals 7 with a carboxyl group, and a filer that is not surface-modified 8. The second layer 3 includes an adhesive binder 9.

FIG. 2 illustrates a separator in which the first layer 2 and the second layer 3 are located on one surface of the porous substrate 1, but a separator in which both the first layer 2 and the second layer 3 are located on both surfaces of the porous substrate 1 may also be included in the scope of the present disclosure.

### Rechargeable Lithium Battery

According to one example embodiment, the rechargeable lithium battery includes the separator for a rechargeable lithium battery, a positive electrode, and a negative electrode.

The separator for rechargeable lithium battery refers to the description described above. The separator for rechargeable lithium battery may be positioned between the positive electrode and the negative electrode.

### Positive Electrode

A positive electrode for a rechargeable lithium battery may include a current collector, and a positive electrode active material layer on the current collector. The positive electrode active material layer may include a positive electrode active material, and may further include a binder and/or a conductive material.

For example, the positive electrode may further include an additive that can constitute a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free lithium nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0≤α≤2); LiₐNi_{1-b-c}Mn_{b}X_{c}O_{2-α}D_{α} (0.90≤a≤1.8, 0≤b≤0.5, 0≤c≤0.5, and 0≤α≤2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{i-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃(0≤f≤2); or LiₐFePO₄ (0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

The positive electrode active material may be or include, for example, a high nickel-based positive electrode active material having a nickel content greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

An amount of the positive electrode active material may be in a range of about 90 wt % to about 99.5 wt % based on 100 wt % of the positive electrode active material layer. Amounts of the binder and the conductive material may be in a range of about 0.5 wt % to about 5 wt %, respectively, based on 100 wt % of the positive electrode active material layer.

The binder attaches the positive electrode active material particles to each other, and also attaches the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may impart conductivity (e.g., electrical conductivity) to the electrode. Any material that does not cause chemical change (e.g., does not cause an undesirable chemical change in the rechargeable lithium battery) and that conducts electrons can be used in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, and the like, in the form of a metal powder or a metal fiber; a conductive polymer such as a polyphenylene derivative; or a mixture thereof.

Al may be used as the current collector, but the current collector is not limited thereto.

### Negative Electrode

The negative electrode for a rechargeable lithium battery may include a current collector, and a negative electrode active material layer on the current collector. The negative electrode active material layer may include a negative electrode active material, and may further include a binder and/or a conductive material (e.g., an electrically conductive material).

For example, the negative electrode active material layer may include a range of about 90 wt % to about 99 wt % of the negative electrode active material, a range of about 0.5 wt % to about 5 wt % of the binder, and a range of about 0 wt % to about 5 wt % of the conductive material.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be present between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

The binder may attach the negative electrode active material particles to each other, and may also attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in the form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be used alone, or in combination of two or more solvents.

In addition, when using a carbonate-based solvent, a cyclic carbonate and a chain carbonate may be mixed together, and the cyclic carbonate and the chain carbonate may be mixed in a volume ratio in a range of about 1:1 to about 1:9.

The lithium salt dissolved in the organic solvent supplies lithium ions in a battery, enables an operation of a rechargeable lithium battery, and improves transportation of the lithium ions between positive and negative electrodes. Examples of the lithium salt include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers in a range of 1 to 20), lithium trifluoromethane sulfonate, lithium tetrafluoroethanesulfonate, lithium difluorobis(oxalato)phosphate (LiDFBOP), and lithium bis(oxalato) borate (LiBOB).

The rechargeable lithium battery may be classified into cylindrical, prismatic, pouch, or coin-type batteries, and the like depending on the shape thereof.

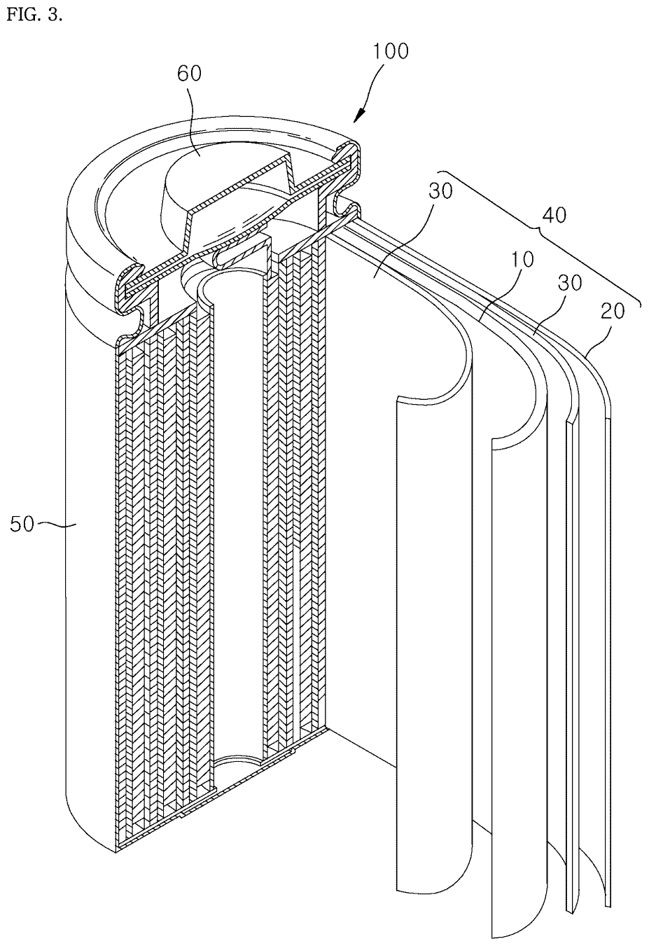

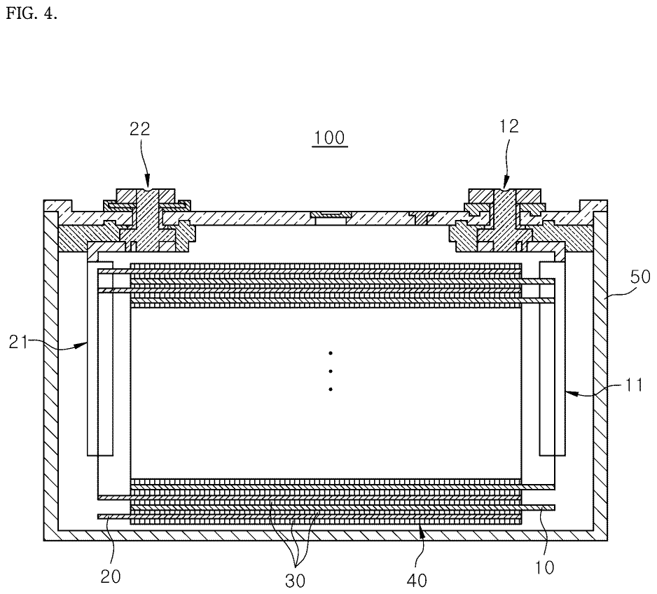

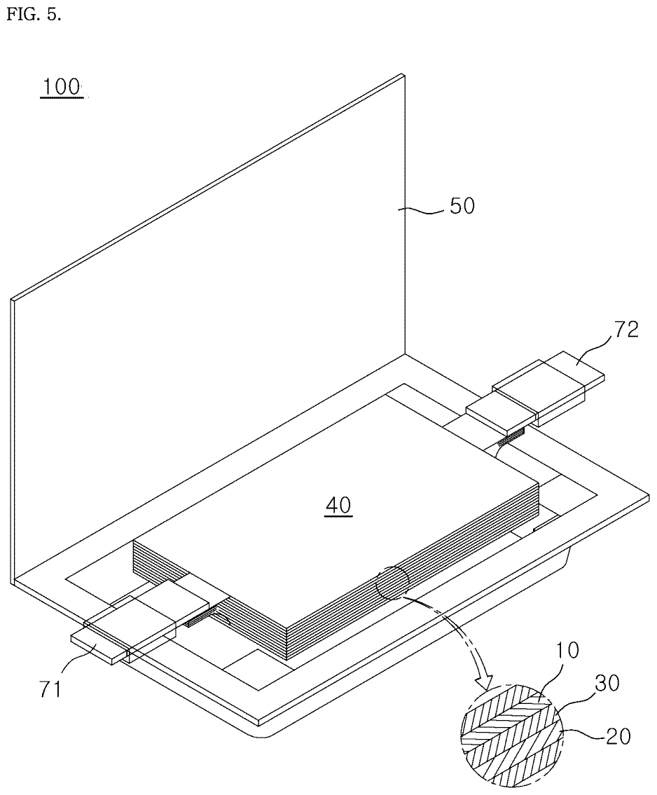

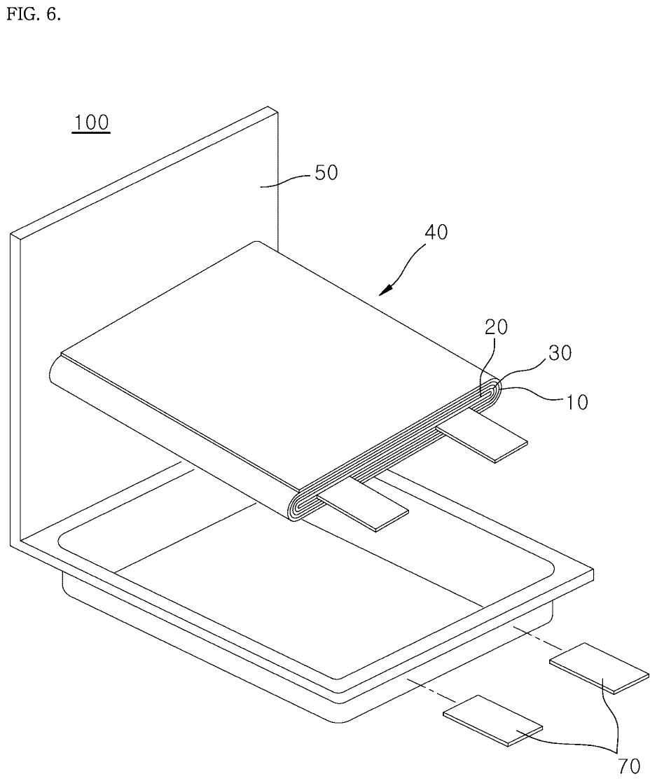

FIG. 3 to FIG. 6 are schematic views illustrating a rechargeable lithium battery according to an example embodiment. FIG. 3 shows a cylindrical battery, FIG. 4 shows a prismatic battery, and FIG. 5 and FIG. 6 show pouch-type batteries. Referring to FIG. 3 to FIG. 6, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 sealing the case 50, as shown in FIG. 3. In FIG. 4, the rechargeable lithium battery 100 may include a positive lead tab 11, a positive terminal 12 connected to the positive lead tab 11, a negative lead tab 21, and a negative terminal 22 connected to the negative lead tab 21. As shown in FIG. 5 and FIG. 6, the rechargeable lithium battery 100 may include an electrode tab 70 illustrated in FIG. 6, or for example, a positive electrode tab 71 and a negative electrode tab 72 illustrated in FIG. 5, the electrode tabs 70/71/72 forming an electric path for inducing the current formed in the electrode assembly 40 to the outside of the battery 100.

The rechargeable lithium battery according to an example embodiment may be applicable to, e.g., automobiles, mobile phones, and/or various types of electric devices, as non-limiting examples.

Hereinafter, examples and comparative examples of the present disclosure are described. However, the following examples are merely provided to illustrate the present disclosure, and the present disclosure is not limited to the following examples.

### Preparation Example 1

In a 10 L four-neck flask equipped with a stirrer, a thermometer, and a condenser, after adding distilled water (6,361 g), acrylic acid (1.0 mol), acrylamide (8.5 mol), potassium persulfate (0.01 mol), 2-acrylamido-2-methylpropanesulfonic acid (0.5 mol), and a 5N lithium hydroxide aqueous solution (1.05 equivalent with respect to the total amount of the 2-acrylamido-2-methylpropanesulfonic acid), and the operation of reducing the inner pressure to 10 mmHg using a diaphragm pump and returning the pressure to normal pressure with nitrogen was repeated three times.

The reaction was performed for 12 hours while controlling the temperature of the reaction solution to be stabilized between 65 to 70° C. After cooling to room temperature, the pH of the reaction solution was adjusted to 7 to 8 using a 25% aqueous ammonia solution.

By the above-described method, poly(acrylic acid-co-acrylamide-co-2-acrylamido-2-methylpropanesulfonic acid) lithium salt was prepared. Here, the molar ratio of a structural unit derived from acrylic acid, a structural unit derived from acrylamide, and a structural unit derived from 2-acrylamido-2-methylpropanesulfonic acid was 10:85:5. About 10 mL of the reaction solution (reaction product) was taken and the content of a non-volatile component was measured, which was 9.5 wt % (theoretical value: 10 wt %).

### Preparation Example 2

A binder was prepared in the same manner as in Preparation Example 1, except that the molar ratio of the structural unit derived from acrylamide and the structure unit derived from 2-acrylamido-2-methylpropanesulfonic acid was 85:15.

### Example 1

Cellulose nanofibers having a carboxyl group were prepared through TEMPO catalytic oxidation treatment, which includes adding cellulose nanofibers to water, adding 2,2,6,6-tetramethylpiperidine-1-oxyl radical (TEMPO), adding an aqueous sodium hypochlorite (NaClO) solution when the pH of the reaction solution was 10, and stirring the resulting solution for 2 hours.

Cellulose nanocrystals having a carboxyl group were prepared through TEMPO catalytic oxidation treatment, which includes adding cellulose nanocrystals to water, adding TEMPO, adding an aqueous NaClO solution when the pH of the reaction solution was 10, and stirring the resulting solution for 2 hours.

A composition for forming a first layer was prepared by mixing the acrylic binder prepared in Preparation Example 1 (10 wt % in distilled water), polyacrylic acid (PAA, weight average molecular weight: 300,000 g/mol, glass transition temperature: 5° C.), cellulose nanofibers having a carboxyl group (TOCNF), cellulose nanocrystals having a carboxyl group (cCNC), boehmite (particle diameter (D100): 0.5 μm, particle diameter (D50): 0.2 μm, plate-like), putting the resulting mixture into water as a solvent, milling and dispersing the resulting solution using a bead mill at 25° C. for 30 minutes, and then adding water to have a total solid content of 20 wt %.

The composition for forming a first layer includes 90 parts by weight of the acrylic binder of Preparation Example 1 and 10 parts by weight of the polyacrylic acid based on 100 parts by weight of the total of the acrylic binder and the polyacrylic acid.

The composition for forming a first layer includes 0.05 parts by weight of the cellulose nanofibers having a carboxyl group and 0.15 parts by weight of the cellulose nanocrystals having a carboxyl group with respect to 100 parts by weight of the total of the acrylic binder of Preparation Example 1 and the polyacrylic acid.

In the composition for forming a first layer, the mass ratio of the total of the acrylic binder of Preparation Example 1 and the polyacrylic acid to boehmite is 1:20.

A separator for a rechargeable lithium battery was prepared by coating both surfaces of a polyethylene-based film (thickness: 5.5 m, CZMZ, air permeability: 115 sec/100 cc, puncture strength: 360 kgf) as a porous substrate with the composition for forming a first layer to a thickness of 0.9 m by a die coating method, and drying the resulting film in an oven at 70° C. for 30 minutes.

### Examples 2 to 7

Separators were prepared in the same manner as in Example 1, except the composition of a first layer in Example 1 was changed as shown in Table 1 below.

### Comparative Examples 1 to 6

Separators were prepared in the same manner as in Example 1, except the composition of a first layer in Example 1 was changed as shown in Table 1 below.

The physical properties of the separators of the Examples and the Comparative Examples were evaluated as follows.

### Air Permeability (Units: Sec/100 cc)

Air permeability was measured by measuring the time it takes for 100 cc of air to pass through each separator (units: see) using a measuring device (EG01-55-1MR, Asahi Seiko).

### Substrate Adhesion (Units: N/12 mm)

A sample was manufactured by cutting each separator into a size of 3 cm (width)×8 cm (length). An adhesive tape (3M) was attached to a first layer surface of the sample in a machine direction of the separator, the tape-adhered surface and the substrate were separated approximately 10 mm to 20 mm apart, the substrate side to which the tape was not attached was fixed to the upper grip and the tape-adhered first layer side was fixed to the lower grip at a gap between the grips of 20 mm and peeled by pulling in the 1800 direction. Here, the peeling rate was 10 mm/min, and an average value was obtained by measuring the force needed to peel 40 mm from the start of peeling three times.

### Dry Heat Shrinkage Rate (Units: %)

Samples were prepared by cutting the separators for a rechargeable lithium battery of the Examples and the Comparative Examples into a size of 10 cm×10 cm. After leaving each sample in an oven at 150° C. for 1 hour, heat shrinkage rates in a machine direction (MD) and a transverse direction (TD) of each sample were calculated by measuring the dimensions of the sides of the rectangular sample. The heat shrinkage rates were calculated by Mathematical Formula 1 below.

$$Mathematical Formula 1$$

$$Heat shrinkage rate = ( L 0 - L 1 ) / L 0 \times 100.$$

L0 is the initial length of the separator, and L1 is the length of the separator after leaving it at 150° C. for 1 hour.

TABLE 1

| | | | | | | | | Dry heat | |
|---|---|---|---|---|---|---|---|---|---|
| | | | | | | | | shrinkage | |
| | First | Second | Mass | | | Air | Substrate | rate | |
| | binder | binder | ratio* | TOCNF | cCNC | permeability | adhesion | MD | TD |
| Example1 | Preparation | PAA | 90:10 | 0.05 | 0.15 | 121 | 0.7 | 3 | 2 |
| | Example | | | | | | | | |
| | 1 | | | | | | | | |
| Example2 | Preparation | PAA | 90:10 | 0.1 | 0.1 | 123 | 0.8 | 2 | 1 |
| | Example | | | | | | | | |
| | 1 | | | | | | | | |
| Example3 | Preparation | PAA | 90:10 | 0.15 | 0.05 | 126 | 0.7 | 2 | 1 |
| | Example | | | | | | | | |
| | 1 | | | | | | | | |
| Example4 | Preparation | PAA | 75:25 | 0.05 | 0.15 | 138 | 0.9 | 2 | 1 |
| | Example | | | | | | | | |
| | 1 | | | | | | | | |
| Example5 | Preparation | PAA | 75:25 | 0.1 | 0.1 | 141 | 1.2 | 1 | 1 |
| | Example | | | | | | | | |
| | 1 | | | | | | | | |
| Example6 | Preparation | PAA | 75:25 | 0.15 | 0.05 | 142 | 1.1 | 1 | 1 |
| | Example | | | | | | | | |
| | 1 | | | | | | | | |
| Example7 | Preparation | PVA | 90:10 | 0.05 | 0.15 | 125 | 0.7 | 2 | 1 |
| | Example | | | | | | | | |
| | 2 | | | | | | | | |
| Comparative | Preparation | PAA | 90:10 | — | — | 131 | 0.2 | 7 | 5 |
| Example 1 | Example | | | | | | | | |
| | 1 | | | | | | | | |
| Comparative | Preparation | PAA | 90:10 | 0.2 | — | 144 | 0.4 | 6 | 4 |
| Example2 | Example | | | | | | | | |
| | 1 | | | | | | | | |
| Comparative | Preparation | PAA | 90:10 | — | 0.2 | 150 | 0.4 | 7 | 4 |
| Example3 | Example | | | | | | | | |
| | 1 | | | | | | | | |
| Comparative | Preparation | PAA | 75:25 | — | — | 149 | 0.3 | 8 | 5 |
| Example4 | Example | | | | | | | | |
| | 1 | | | | | | | | |
| Comparative | Preparation | PAA | 75:25 | 0.2 | — | 152 | 0.4 | 6 | 4 |
| Example5 | Example | | | | | | | | |
| | 1 | | | | | | | | |
| Comparative | Preparation | PAA | 75:25 | — | 0.2 | 147 | 0.4 | 6 | 5 |
| Example6 | Example | | | | | | | | |
| | 1 | | | | | | | | |

*Mass ratio: first binder: second binder mass ratio
*PVA: polyvinyl alcohol

### EXAMPLE

As shown in Table 1 above, the separators for a rechargeable lithium battery of Examples provide high substrate adhesion, a low heat shrinkage rate, and improved air permeability to increase the safety and lifetime of a battery.

However, as shown in Table 1, the separators of Comparative Examples, which did not satisfy the first layer composition in the present disclosure have higher air permeability, a higher heat shrinkage rate, or lower substrate adhesion than those of the Examples.

### Example 8

Cellulose nanofibers having a carboxyl group were prepared through TEMPO catalytic oxidation treatment, which includes adding cellulose nanofibers to water, adding 2,2,6,6-tetramethylpiperidine-1-oxyl radical (TEMPO), adding an aqueous sodium hypochlorite (NaClO) solution when the pH of the reaction solution was 10, and stirring the resulting solution for 2 hours.

Cellulose nanocrystals having a carboxyl group were prepared through TEMPO catalytic oxidation treatment, which includes adding cellulose nanocrystals to water, adding TEMPO, adding an aqueous NaClO solution when the pH of the reaction solution was 10, and stirring the resulting solution for 2 hours.

A composition for forming a first layer was prepared by mixing the acrylic binder prepared in Preparation Example 1 (10 wt % in distilled water), polyacrylic acid, cellulose nanofibers having a carboxyl group, cellulose nanocrystals having a carboxyl group, and boehmite (particle diameter (D100): 0.5 μm, particle diameter (D50): 0.2 μm, plate-like), putting the resulting mixture to water as a solvent, milling and dispersing the resulting solution using a bead mill at 25° C. for 30 minutes, and then adding water to have a total solid content of 20 wt %.

The composition for forming a first layer includes 90 parts by weight of the acrylic binder of Preparation Example 1 and 10 parts by weight of the polyacrylic acid (PAA, weight average molecular weight: 300,000 g/mol, glass transition temperature: 5° C.) based on 100 parts by weight of the total of the acrylic binder and the polyacrylic acid.

The composition for forming a first layer includes 0.05 parts by weight of the cellulose nanofibers having a carboxyl group and 0.15 parts by weight of the cellulose nanocrystals having a carboxyl group with respect to 100 parts by weight of the total of the acrylic binder of Preparation Example 1 and the polyacrylic acid.

In the composition for forming a first layer, the mass ratio of the total of the acrylic binder of Preparation Example 1 and the polyacrylic acid to boehmite is 1:20.

A first layer was prepared by coating both surfaces of a polyethylene-based film (thickness: 5.5 μm, CZMZ, air permeability: 115 sec/100 cc, puncture strength: 360 kgf) as a porous substrate with the composition for forming a first layer to a thickness of 0.9 m by a die coating method, and drying the resulting film in an oven at 70° C. for 30 minutes.

A second layer was formed by coating the first layer with crosslinked polymethylmethacrylate (PMMA) as an adhesive binder to a thickness of 0.45 m, and drying the second layer at 70° C. for 30 minutes in an oven, thereby preparing a separator for a rechargeable lithium battery.

### Examples 9 to 14

Separators were prepared in the same manner as in Example 8, except the compositions of a first layer and a second layer were changed as shown in Table 2 below.

### Comparative Examples 7 to 12

Separators were prepared in the same manner as in Example 8, except the compositions of a first layer and a second layer were changed as shown in Table 2 below.

The physical properties of the separators of Examples and Comparative Examples were evaluated as follows.

### Air Permeability (Units: Sec/100 cc)

Air permeability was measured in the same manner as described above.

### Substrate Adhesion (Units: N/12 mm)

A sample was manufactured by cutting each separator into a size of 3 cm (width)×8 cm (length). An adhesive tape (3M) was attached to a second layer surface of the sample in a machine direction of the separator, the tape-adhered surface and the substrate were separated approximately 10 mm to 20 mm apart, the substrate side to which the tape was not attached was fixed to the upper grip and the tape-adhered second layer side was fixed to the lower grip at a gap between the grips of 20 mm and peeled by pulling in the 1800 direction. Here, the peeling rate was 10 mm/min, and an average value was obtained by measuring the force needed to peel 40 mm from the start of peeling three times.

### Dry Heat Shrinkage Rate (Units: %)

A dry heat shrinkage rate was measured in the same manner as described above.

### Dry Adhesion to Positive Electrode (Units: Gf/Mm)

Each of the separators for a rechargeable lithium battery of Examples and Comparative Examples was cut to a size of 5 cm×5 cm, thereby preparing a sample.

A positive electrode slurry was prepared by mixing 97 wt % of lithium-cobalt-nickel-aluminum-based LiCoNiAl as a positive electrode active material, 1.5 wt % of carbon nanotubes as a conductive material, and 1.5 wt % of polyvinyl fluoride and adding N-methyl-2-pyrrolidone. A positive electrode was manufactured by coating an aluminum foil with the prepared positive electrode slurry, and then drying and pressing the slurry-coated aluminum foil. The positive electrode was cut to a size of 5 cm×5 cm, thereby preparing a sample.

The separator and the positive electrode were maintained for 2 hours under conditions of 40° C. and a load of 50 kg. Afterward, the separator and the positive electrode were separated approximately 10 mm to 20 mm apart, the separator was fixed to an upper grip while the positive electrode was fixed to a lower grip with a 20 mm gap between the grips, and the separator was pulled at a speed of 100 mm/min in a direction of 1800 from the positive electrode. The force required to peel 40 mm was measured three times, and the arithmetic mean value was calculated. An adhesive strength was measured using a UTM.

### Dry Adhesion to Negative Electrode (Units: Gf/Mm)

Each of the separators for a rechargeable lithium battery of Examples and Comparative Examples was cut to a size of 5 cm×5 cm, thereby preparing a sample.

A negative electrode slurry was prepared by mixing 97.4 wt % of artificial graphite as a negative electrode active material, 1.0 wt % of carboxymethylcellulose, 1.5 wt % of styrene-butadiene-based rubber, and 0.1 wt % of carbon nanotubes as a conductive material, and mixing distilled water. A negative electrode was manufactured by coating a copper foil with the prepared negative electrode slurry, and then drying and rolling the slurry-coated copper foil. The negative electrode was cut to a size of 5 cm×5 cm, thereby preparing a sample.

The separator and the negative electrode were maintained for 2 hours under conditions of 40° C. and a load of 50 kg. Afterward, the separator and the negative electrode were separated approximately 10 mm to 20 mm apart, the separator was fixed to an upper grip while the negative electrode was fixed to a lower grip with a 20 mm gap between the grips, and the separator was pulled at a speed of 100 mm/min in a direction of 180° from the negative electrode. The force required to peel 40 mm was measured three times, and the arithmetic mean value was calculated. An adhesive strength was measured using a UTM.

### Wet Adhesion to Positive Electrode or Negative Electrode (Units: Gf/Mm)

Each of the separators for a rechargeable lithium battery of Examples and Comparative Examples was cut to a size of 5 cm×5 cm, thereby preparing a sample.

A positive electrode slurry was prepared by mixing 97 wt % of lithium-cobalt-nickel-aluminum-based LiCoNiAl as a positive electrode active material, 1.5 wt % of carbon nanotubes as a conductive material, and 1.5 wt % of polyvinyl fluoride, and adding N-methyl-2-pyrrolidone. A positive electrode was manufactured by coating an aluminum foil with the positive electrode slurry, and drying and rolling the slurry-coated aluminum foil.

A negative electrode slurry was prepared by mixing 97.4 wt % of artificial graphite as a negative electrode active material, 1.0 wt % of carboxymethylcellulose, 1.5 wt % of styrene-butadiene-based rubber, and 0.1 wt % of carbon nanotubes as a conductive material, and adding distilled water. A negative electrode was manufactured by coating a copper foil with the prepared negative electrode slurry, and drying and rolling the slurry-coated copper foil.

Three sets of positive electrode-sample-negative electrode laminates were prepared by placing one layer of the sample between the positive electrode and the negative electrode, and then put into a pouch. A rechargeable lithium battery was manufactured by injecting 2 g of an electrolyte (1.5M LiPF₆ dissolved in a mixed solvent of ethylene carbonate, ethyl methyl carbonate, and dimethyl carbonate (a volume ratio of 30:50:20 based on a total volume of 100)), completely saturating the laminates in the electrolyte, sealing and then leaving the laminates for 12 hours at 25° C.

The manufactured rechargeable lithium battery was maintained for 2 hours under conditions of 40° C. and a load of 50 kg. Afterward, the separator and the positive electrode were separated approximately 10 mm to 20 mm apart, the separator was fixed to an upper grip while the positive electrode was fixed to a lower grip with a 20 mm gap between the grips, and the separator was pulled at a speed of 100 mm/min in a direction of 1800 from the positive electrode. The force required to peel 40 mm was measured three times, and the arithmetic mean value was calculated. An adhesive strength was measured using a UTM.

Wet adhesion was also assessed for the negative electrode in the same manner as described above.

TABLE 2

| | | | | | | | | | Heat | | Dry | | Wet | |
|---|---|---|---|---|---|---|---|---|---|---|---|---|---|---|
| | | | | | | Adhe- | Air | Sub- | shrinkage | | adhesion | | adhesion | |
| | First | Second | Mass | | | sive | perme- | strate | rate | | Positive | Negative | Positive | Negative |
| | binder | binder | ratio | TOCNF | cCNC | binder | ability | adhesion | MD | TD | electrode | electrode | electrode | electrode |
| Example | Prepa- | PAA | 90:10 | 0.05 | 0.15 | PMMA | 121 | 0.7 | 3 | 2 | 0.9 | 0.9 | 1.1 | 1.0 |
| 8 | ration | | | | | | | | | | | | | |
| | Example | | | | | | | | | | | | | |
| | 1 | | | | | | | | | | | | | |
| Example | Prepa- | PAA | 90:10 | 0.1 | 0.1 | PMMA | 123 | 0.8 | 2 | 1 | 1.0 | 1.1 | 1.2 | 1.1 |
| 9 | ration | | | | | | | | | | | | | |
| | Example | | | | | | | | | | | | | |
| | 1 | | | | | | | | | | | | | |
| Example | Prepa- | PAA | 90:10 | 0.15 | 0.05 | PMMA | 126 | 0.7 | 2 | 1 | 1.0 | 1.0 | 1.2 | 1.1 |
| 10 | ration | | | | | | | | | | | | | |
| | Example | | | | | | | | | | | | | |
| | 1 | | | | | | | | | | | | | |
| Example | Prepa- | PAA | 75:25 | 0.05 | 0.15 | PMMA | 138 | 0.9 | 2 | 1 | 1.3 | 1.2 | 1.3 | 1.2 |
| 11 | ration | | | | | | | | | | | | | |
| | Example | | | | | | | | | | | | | |
| | 1 | | | | | | | | | | | | | |
| Example | Prepa- | PAA | 75:25 | 0.1 | 0.1 | PMMA | 141 | 1.2 | 1 | 1 | 1.5 | 1.4 | 1.5 | 1.4 |
| 12 | ration | | | | | | | | | | | | | |
| | Example | | | | | | | | | | | | | |
| | 1 | | | | | | | | | | | | | |
| Example | Prepa- | PAA | 75:25 | 0.15 | 0.05 | PMMA | 142 | 1.1 | 1 | 1 | 1.5 | 1.4 | 1.4 | 1.4 |
| 13 | ration | | | | | | | | | | | | | |
| | Example | | | | | | | | | | | | | |
| | 1 | | | | | | | | | | | | | |
| Example | Prepa- | PVA | 90:10 | 0.05 | 0.15 | PMMA | 125 | 0.7 | 2 | 1 | 0.9 | 1.0 | 1.0 | 1.1 |
| 14 | ration | | | | | | | | | | | | | |
| | Example | | | | | | | | | | | | | |
| | 2 | | | | | | | | | | | | | |
| Compar- | Prepa- | PAA | 90:10 | — | — | PMMA | 131 | 0.2 | 7 | 5 | 0.6 | 0.7 | 0.7 | 0.6 |
| ative | ration | | | | | | | | | | | | | |
| Example | Example | | | | | | | | | | | | | |
| 7 | 1 | | | | | | | | | | | | | |
| Compar- | Prepa- | PAA | 90:10 | 0.2 | — | PMMA | 144 | 0.4 | 6 | 4 | 0.6 | 0.6 | 0.7 | 0.7 |
| ative | ration | | | | | | | | | | | | | |
| Example | Example | | | | | | | | | | | | | |
| 8 | 1 | | | | | | | | | | | | | |
| Compar- | Prepa- | PAA | 90:10 | — | 0.2 | PMMA | 150 | 0.4 | 7 | 4 | 0.7 | 0.6 | 0.7 | 0.6 |
| ative | ration | | | | | | | | | | | | | |
| Example | Example | | | | | | | | | | | | | |
| 9 | 1 | | | | | | | | | | | | | |
| Compar- | Prepa- | PAA | 75:25 | — | — | PMMA | 149 | 0.3 | 8 | 5 | 0.8 | 0.8 | 0.9 | 0.8 |
| ative | ration | | | | | | | | | | | | | |
| Example | Example 1 | | | | | | | | | | | | | |
| 10 | | | | | | | | | | | | | | |
| Compar- | Prepa- | PAA | 75:25 | 0.2 | — | PMMA | 152 | 0.4 | 6 | 4 | 0.8 | 0.7 | 0.9 | 0.8 |
| ative | ration | | | | | | | | | | | | | |
| Example | Example | | | | | | | | | | | | | |
| 11 | 1 | | | | | | | | | | | | | |
| Compar- | Prepa- | PAA | 75:25 | — | 0.2 | PMMA | 147 | 0.4 | 6 | 5 | 0.8 | 0.8 | 0.9 | 0.8 |
| ative | ration | | | | | | | | | | | | | |
| Example | Example | | | | | | | | | | | | | |
| 12 | 1 | | | | | | | | | | | | | |

*Mass ratio: mass ratio of first binder: second binder
*PVA: polyvinyl alcohol

As shown in Table 2 above, the separators for a rechargeable lithium battery of Examples can provide high substrate adhesion, a low heat shrinkage rate, and improved air permeability, and also provide high dry adhesion, and high wet adhesion.

However, as shown in Table 2 above, the separators of Comparative Examples did not provide the same effects as the effects of Examples described above.

Although the example embodiments of the present disclosure have been described above, the present disclosure is not limited thereto, and it is possible to implement various modifications within the scope of the claims, the detailed description of the present disclosure, and the accompanying drawings. It is obvious that these modifications also fall within the scope of the present disclosure.

What is claimed is:

1. A separator for a rechargeable lithium battery, the separator comprising:
a porous substrate; and
a first layer located on at least one surface of the porous substrate;
wherein the first layer comprises a binder and a filler,
the binder comprises a mixture of a first binder and a second binder,
the second binder is an adhesive binder and comprises one or more of polyvinyl alcohol, polyacrylic acid, and poly(vinyl alcohol-co-acrylic acid), and
the filler comprises a mixture of cellulose-based nanofibers having a carboxyl group or carboxylate, cellulose-based nanocrystals having a carboxyl group or carboxylate, and a filler that is not surface-modified.

2. The separator of claim 1, wherein the second binder has a weight average molecular weight in a range of about 100,000 g/mol to about 800,000 g/mol, and a glass transition temperature in a range of about −20° C. to about 30° C.

3. The separator of claim 1, wherein the first binder is included in an amount of about 75 parts by weight to about 90 parts by weight, and the second binder is included in an amount in a range of about 10 parts by weight to about 25 parts by weight based on 100 parts by weight of a total of the first binder and the second binder.

4. The separator of claim 1, wherein a mixture of the cellulose-based nanofibers having a carboxyl group or carboxylate and the cellulose-based nanocrystals having a carboxyl group or carboxylate is included in an amount in a range of about 0.1 parts by weight to about 0.5 parts by weight based on 100 parts by weight of the mixture of the first binder and the second binder.

5. The separator of claim 1, wherein the cellulose-based nanofibers having a carboxyl group or carboxylate and the cellulose-based nanocrystals having a carboxyl group or carboxylate are included in the first layer in a weight ratio in a range of about 1:0.1 to about 1:5.

6. The separator of claim 1, wherein the cellulose-based nanocrystals having a carboxyl group or carboxylate have a maximum width in a range of about 5 nm to about 20 nm, and a maximum length in a range of about 100 nm to about 250 nm.

7. The separator of claim 1, wherein the cellulose-based nanofibers having a carboxyl group or carboxylate have a maximum diameter in a range of about 3 nm to about 4 nm and a maximum length of about 1 m or more.

8. The separator of claim 1, wherein the cellulose-based nanocrystals having a carboxyl group or carboxylate have a carboxyl group or carboxylate linked to C6 in the cellulose unit.

9. The separator of claim 1, wherein the cellulose-based nanofibers having a carboxyl group or carboxylate have a carboxyl group or carboxylate linked to C6 in the cellulose unit.

10. The separator of claim 1, wherein the filler that is not surface-modified comprises plate-like boehmite.

11. The separator of claim 1, wherein the filler that is not surface-modified has a particle diameter (D100) of about 1.0 m or less.

12. The separator of claim 1, wherein the mixture of the first binder and the second binder and the filler are included in a mass ratio in a range of about 1:10 to about 1:50.

13. The separator of claim 1, wherein the first binder comprises a (meth)acrylic binder having a structural unit containing a sulfonate group.

14. The separator of claim 13, wherein the (meth)acrylic binder further comprises one or more of a structural unit derived from (meth)acrylate or (meth)acrylic acid, a structural unit containing a cyano group, and a structural unit derived from (meth)acryl amide.

15. The separator of claim 1, wherein a second layer is further formed on the first layer.

16. The separator of claim 15, wherein the second layer comprises one or more of an acrylic adhesive binder and a polyvinylidene fluoride-based adhesive binder.

17. A rechargeable lithium battery comprising:
the separator for a rechargeable lithium battery of claim 1;
a positive electrode; and
a negative electrode.
